(19) United States
(12) Patent Application Publication
(10) Pub. No.: US 2009/0277758 A1
(43) Pub. Date: Nov. 12, 2009

(54) ENCLOSURE MEMBER

(75) Inventor: Christopher Marshall, Holmfirth (GB)

Correspondence Address: TRASKBRITT, P.C., P.O. BOX 2550, SALT LAKE CITY, UT, 84110, US

(73) Assignee: PENNINE INDUSTRIAL EQUIPMENT LIMITED, Huddersfield (GB)

(21) Appl. No.: 12/436,457

(22) Filed: May 6, 2009

(30) Foreign Application Priority Data
May 7, 2008 (GB) 0808278.6

(51) Int. Cl. B65G 17/06

(52) U.S. Cl. 198/851

(57) ABSTRACT

The present invention relates to a multi-link conveyor chain which may be used (for example) in the glass industry and to an enclosure member for use in the multi-link conveyor chain.

### BACKGROUND OF THE INVENTION

1. Field of the Invention

The present invention relates to a multi-link conveyor chain which may be used (for example) in the glass industry and to an enclosure member for use in the multi-link conveyor chain.

2. State of the Art

Multi-link conveyor chains are in widespread use in the glass industry for transporting glass products between processing stations. For example, a multi-link conveyor chain which is typically 100 feet long may be used to transport blown glass from a blowing station to an annealing station. In one conventional multi-link conveyor chain, there is a plurality of parallel spaced apart elongate pins having an oval-shaped cross-section. Mounted on adjacent elongate pins are a series of link plates spaced apart along the pin by a plurality of washers, each link plate comprising a first and a second link. Each of the first and second link is capable of engaging a drive sprocket and has an oval-shaped aperture for receiving the elongate pin. The multi-link conveyor chain is driven by the engagement of the links of the link plate with the multiple teeth of a drive sprocket during a cycle of engagement.

The conventional multi-link conveyor chain is assembled so that each end of the elongate pin extends beyond the outermost link plate (i.e., beyond the edge of the flat conveyor surface) and a pin head is fixed to each exposed end. During assembly a minimum amount of head clearance (the distance between the outer face of the outermost link plate to the outer face of the pin head) is introduced into the chain. This is typically 2-2.5 mm to ensure that the chain is sufficiently loose for extreme applications. A disadvantage of this arrangement is that unless the guide strip adjacent to the multi-link conveyor chain is in perfect alignment with the edge of the multi-link conveyor chain, there is a tendency for the pin head to wear and eventually shear off so that the elongate pin may become dislodged. In extreme cases, this results in total collapse of the multi-link conveyor chain.

### BRIEF SUMMARY OF THE INVENTION

One way to seek to overcome these disadvantages is to enclose and secure each end of an elongate pin in a protective enclosure member (e.g., a head protector). One such arrangement is described in EP-A-1241117. The head clearance in this arrangement is typically about 0.05-1 mm which is less than the head clearance in the conventional chain described above. This lower head clearance reflects a need to ensure that the pin head does not protrude from the enclosure member and to ensure that the chain does not have a propensity to lock up. However in certain circumstances, the lower head clearance compromises the performance of the chain.

The present invention seeks to improve the performance of a multi-link conveyor chain by exploiting a novel enclosure member having a deep countersink to accommodate a pin head clearance which strikes a better balance between the need to ensure that the pin head does not protrude from the enclosure member and to ensure that the chain does not have a propensity to lock up.

Thus viewed from one aspect the present invention provides a multi-link conveyor chain adapted to provide a substantially flat horizontal surface driveable between a first and a second processing station by engagement with a drive sprocket, said multi-link conveyor chain comprising:

a plurality of elongate pins spaced apart in substantially parallel relationship including a first elongate pin adjacent to a second elongate pin,

wherein the first elongate pin has a first end extending beyond a first edge of the substantially flat horizontal surface and a second end extending beyond a second edge of the substantially flat horizontal surface and

wherein the second elongate pin has a first end extending beyond the first edge of the substantially flat horizontal surface and a second end extending beyond the second edge of the substantially flat horizontal surface;

a plurality of link plates mounted on adjacent elongate pins having a first link connected to a second link by a connecting portion, each of the first and the second link having a main body and a circumferentially dependent sprocket engaging member, said main body defining an aperture whose shape essentially matches the section of an elongate pill;

a first enclosure member positioned at the first edge of the substantially flat horizontal surface comprising:

a main body defining a first aperture and a second aperture, wherein the shape of the first and second aperture essentially matches the section of the first elongate pin and second elongate pin respectively and the depth of the first and second aperture is sufficient to enclose the first end of the first elongate pin and the first end of the second elongate pin respectively;

a second enclosure member positioned at the second edge of the substantially flat horizontal surface comprising:

a main body defining a third aperture and a fourth aperture, wherein the shape of the third and fourth aperture essentially matches the section of the first elongate pin and second elongate pin respectively and the depth of the third and fourth aperture is sufficient to enclose the second end of the first elongate pin and the second end of the second elongate pin respectively; and

a first pin head secured to and retaining the first end of the first elongate pin and seated in a non-tapered counterbore of the first aperture,

a second pin head secured to and retaining the first end of the second elongate pin and seated in a non-tapered counterbore of the second aperture,

a third pin head secured to and retaining the second end of the first elongate pin and seated in a non-tapered counterbore of the third aperture, and

a fourth pin head secured to and retaining the second end of the second elongate pin and seated in a non-tapered counterbore of the fourth aperture,

wherein the ratio of the depth of the non-tapered counterbore to the thickness of the enclosure member is in the range 0.58 to 0.80.

By enclosing the first end and second end of each of the first and second elongate pins in the deep non-tapered counterbore of the first and second enclosure members, the tendency for a rounded pin head exposed beyond the edge of the conveyor surface to “catch” or be sheared off is eliminated but there is sufficient head clearance to ensure that performance is not compromised under circumstances in which there is thermal expansion (e.g., of the link plates) or material deformation. In particular, the deep counterbore ensures that at temperatures in excess of 120° C., locking and tightening in the chain do not occur. Equally when a user requires a top face of the chain to be ground for improved container stability, the deep counterbore serves to ensure that there is sufficient head clearance to accommodate the cumulative effect of folding on the corner of each link plate caused by grinding.

Preferably the ratio of the depth of the non-tapered counterbore to the thickness of the enclosure member is in the range 0.58 to 0.75, particularly preferably 0.58 to 0.70.

Preferably the depth of the non-tapered counterbore is 3.5 mm or more, particularly preferably 4.5 mm or more, more preferably 6 mm or more.

Generally speaking, the first and second enclosure members will be identical. The pin heads may be fully encapsulated within the non-tapered counterbore.

The first, second, third and fourth pin heads may be flat. The first, second, third and fourth flat pin heads may be spin riveted (e.g., eccentrically spin riveted) flat pin heads.

In a preferred embodiment, the multi-link conveyor chain comprises: a plurality of first and second enclosure members as hereinbefore defined positioned respectively at the first and second edges of the substantially flat horizontal surface so as to enclose the first and second end of each of the plurality of elongate members.

In a preferred embodiment, the main body has a substantially trapezoidal section. For example, the main body has a first side substantially parallel to a second side, wherein the second side is longer than the first side and has rounded corners. Preferably the first side has rounded corners (typically to a lesser extent than the second side). In use, the first enclosure member is positioned at the first edge with the second side uppermost. In use, the second enclosure member is positioned at the second edge with the second side uppermost. The rear face of the main body may be recessed (e.g., with a substantially U-shaped recess). The first (shorter) side may be closed or open. Where the first side is open, the main body adopts a twin flat-edged, substantially teardrop profile.

Preferably the shorter side is open. Where the shorter side is open, the enclosure member is particularly useful in centre guide conveyor chains.

Preferably the shorter side is closed and the rear face is recessed. Where the shorter side is closed and the rear face is recessed, the enclosure member is particularly useful in side guide conveyor chains.

Preferably the shorter side is closed and the rear face is non-recessed. Where the shorter side is closed and the rear face is non-recessed, the enclosure member is particularly useful in multi-guide conveyor chains.

Preferably the non-tapered counterbore is substantially cylindrical. Preferably the non-tapered counterbore is a flat recess.

The enclosure member may be sized and configured so as to have a maximum radial extent which is equal to or less than adjacent link plates. This ensures that the enclosure member does not interfere with the substantially flat horizontal surface.

Preferably the first elongate pin has a non-circular section and the second elongate pin has a non-circular section.

Preferably the main body of each of the first and second link of the link plate defines a non-circular aperture whose shape essentially matches the non-circular section of an elongate pin. Preferably the main body of the first enclosure member defines a first non-circular aperture and a second non-circular aperture, wherein the shape of the first and second non-circular aperture essentially matches the non-circular section of the first elongate pin and second elongate pin respectively. Preferably the main body of the second enclosure member defines a third non-circular aperture and a fourth non-circular aperture, wherein the shape of the first and second non-circular aperture essentially matches the non-circular section of the first elongate pin and second elongate pin respectively.

Preferably the main body of each of the first and the second link of a link plate defines an aperture (e.g., a non-circular aperture) whose shape non-identically matches the section (e.g., non-circular section) of the elongate pin. The non-identical match between the section of the elongate pin and the shape of the aperture defined by the main body of the link causes the link plate to be advantageously driven by the elongate pin throughout the cycle of engagement with the drive sprocket.

Preferably the multi-link conveyor comprises: a plurality of elongate pins spaced apart in substantially parallel relationship including a first elongate pin adjacent to a second elongate pin which is adjacent to a third elongate pin, each of said elongate pins having a first end, a second end and a non-circular section, wherein a plurality of link plates are consecutively mounted in a staggered fashion along the first, second and third elongate pin.

In a preferred embodiment, the circumferentially dependent sprocket engaging member of each of the first and second link of the link plate is substantially flat edged. Preferably each of the first and second link of the link plate has a flat-edged, substantially teardrop profile.

Link plates may be mounted consecutively along an elongate pin. Certain (e.g., all) link plates may be spaced apart by one or more spacers. The main body of the or each spacer may define a circular or non-circular aperture. In a preferred embodiment of the invention, each spacer comprises a main body defining a non-circular aperture for receiving the elongate pin whose shape essentially matches the non-circular section of the elongate pin.

Preferably the non-circular section of the elongate pin is substantially elliptical (or oval). Preferably the non-circular aperture defined by the main body of the (or each) link is substantially elliptical (or oval) with an enlarged side portion. Particularly preferably the enlarged side portion extends inwardly towards the connecting portion.

It is expected that the multi-link conveyor chain of the invention will be suitable in any industry which desires transportation between a first and a second station. For example, the multi-link conveyor chain of the invention could be used to transport automotive parts in the automotive industry.

Viewed from a further aspect the present invention provides an enclosure member as hereinbefore defined.

The enclosure member may be fitted to any type of multi-link conveyor chain, in particular those available from Pennine Industrial Equipment Limited (Huddersfield, England) such as their PREMIUM range. It may be fitted to multi-link conveyor chains of ½ inch or 1 inch pitch being link only or link/spacer assemblies of centre guide, side guide or multi-guide type. In each case, it is preferred to fit first and second enclosure members at each end of an adjacent pair of elongate pills.

By way of illustration only, the manufacture of an embodiment of the multi-link conveyor chain of the invention may be achieved by (for example):

(A) spin riveting the first flat pin head to the first end of the first elongate pill;

(B) inserting the second end of the first elongate pin into the first non-circular aperture defined by the main body of the first enclosure member;

(C) inserting the second end of the first elongate pin into the non-circular aperture defined by the first or second link of each of the plurality of link plates to a position where the first flat pin head is seated in the non-tapered counterbore within the first non-circular aperture defined by the main body of the first enclosure member;

(D) inserting the second end of the first elongate pin into the third non-circular aperture defined by the main body of the second enclosure member to a position where the second end is adjacent a non-tapered counterbore within the third non-circular aperture;

(F) eccentrically spin riveting the second end of the first elongate pin to produce the third flat pin head seated in the non-tapered counterbore within the third non-circular aperture defined by the main body of the second enclosure member;

(G) spin riveting the second flat pin head to the first end of the second elongate pin;

(H) inserting the second end of the second elongate pin into the second non-circular aperture defined by the main body of the first enclosure member;

(I) inserting the second end of the second elongate pin into the non-circular aperture defined by the first or second link of each of the plurality of link plates to a position where the second flat pin head is seated in a non-tapered counterbore within the second non-circular aperture defined by the main body of the first enclosure member;

(J) inserting the second end of the second elongate pin into the fourth non-circular aperture defined by the main body of the second enclosure member to a position where the second end is adjacent a non-tapered counterbore within the fourth non-circular aperture; and

(K) eccentrically spin riveting the second end of the second elongate pin to produce a fourth flat pin head seated in the non-tapered counterbore within the fourth non-circular aperture.

Materials suitable for spin riveting are familiar to those skilled in the art (e.g., carbide). Steps (A) and (G) may be carried out by eccentric spin riveting.

The present invention will now be described in a non-limitative sense with reference to the accompanying Figures in which:

### BRIEF DESCRIPTION OF THE SEVERAL VIEWS OF THE DRAWINGS

FIG. 1 illustrates a first embodiment of the enclosure member of the invention in perspective (a) and side (b) views;

FIG. 2 illustrates a second embodiment of the enclosure member of the invention in perspective (a) and side (b) views;

FIG. 3 illustrates a third embodiment of the enclosure member of the invention in perspective (a) and side (b) views; and

FIG. 4 illustrates in partial view an embodiment of the multi-link conveyor chain of the invention.

### DETAILED DESCRIPTION OF THE INVENTION

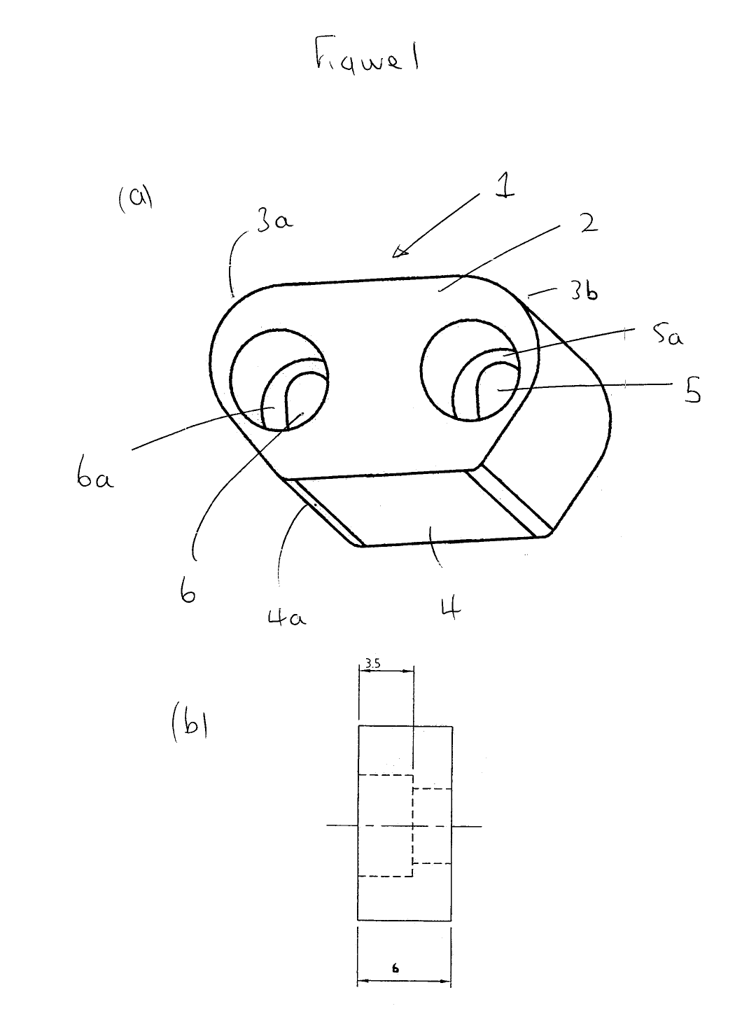

FIG. 1 illustrates a first embodiment of the enclosure member of the invention designated generally by reference numeral 1. The enclosure member 1 is used in multi-guide conveyor chains and has a thickness of 6 mm. The enclosure member 1 comprises a trapezoidal main body 2 having a long side 3 parallel to a closed short side 4. The corners 3a and 3b of the long side 3 are rounded off (and to a lesser extent so are the corners 4a and 4b of the short side 4). The main body 2 defines a first non-circular aperture 5 and a second non-circular aperture 6, each of which are elliptical and provided with a cylindrical counterbore 5a and 6a respectively. The counterbores 5a and 6a are non-tapered and have a depth of 3.5 mm.

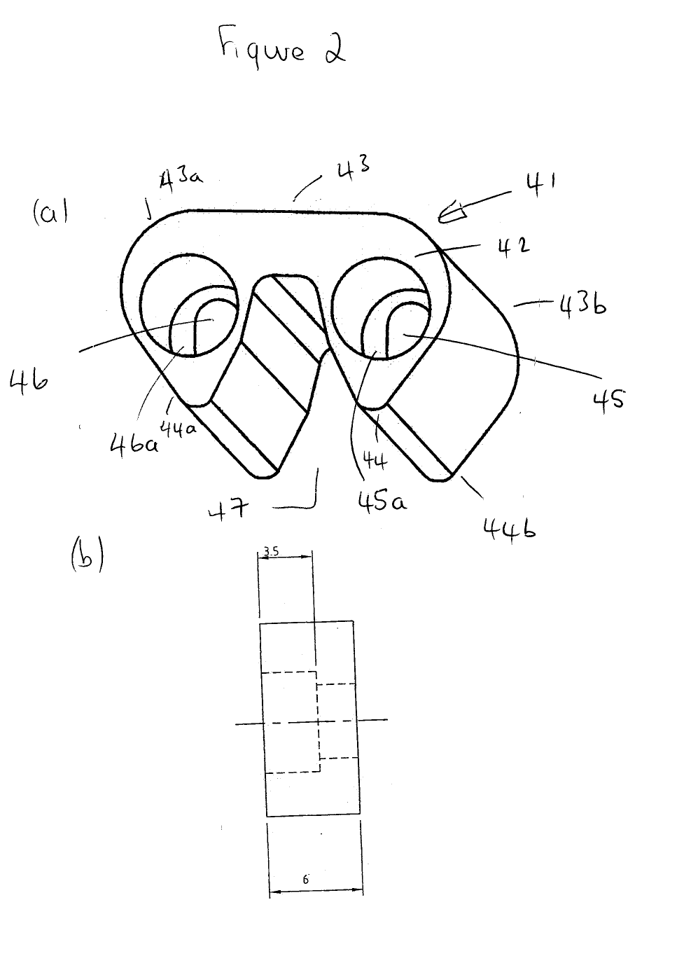

FIG. 2 illustrates a second embodiment of the enclosure member of the invention designated generally by reference numeral 41. The enclosure member 41 is used in centre guide chains and has a thickness of 6 mm. The enclosure member 41 comprises a trapezoidal main body 42 having a long side 43 parallel to an open short side 44. The open short side is defined by a deep U-shaped cut-away portion 47. The corners 43a and 43b of the long side 43 are rounded off (and to a lesser extent so are the corners 44a and 44b of the short side 44). The main body 42 defines a first non-circular aperture 45 and a second non-circular aperture 46, each of which are elliptical and provided with a cylindrical counterbore 45a and 46a respectively. The counterbores 45a and 46a are non-tapered and have a depth of 3.5 mm.

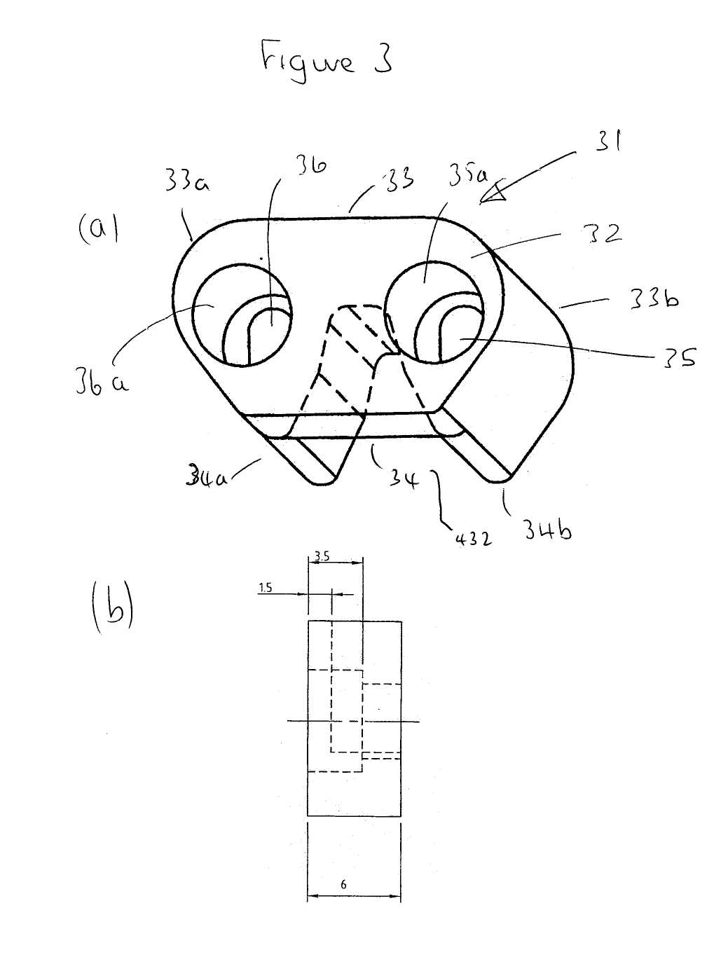

FIG. 3 illustrates a third embodiment of the enclosure member of the invention designated generally by reference numeral 31. The enclosure member 31 is used in side guide chains and has a thickness of 6 mm. The enclosure member 31 comprises a trapezoidal main body 32 having a long side 33 parallel to a closed short side 34. The corners 33a and 33b of the long side 33 are rounded off (and to a lesser extent so are the corners 34a and 34b of the short side 34). The rear face of the main body 32 is partially recessed with a substantially U-shaped recess 432. The main body 32 defines a first non-circular aperture 35 and a second non-circular aperture 36, each of which are elliptical and provided with a cylindrical counterbore 35a and 36a respectively. The counterbores 35a and 36a are non-tapered and have a depth of 3.5 mm.

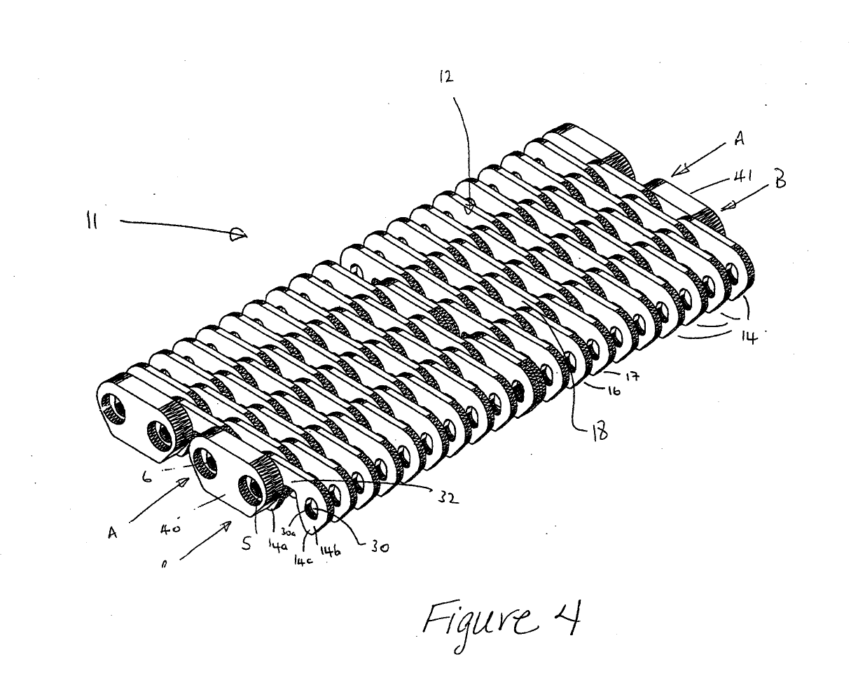

FIG. 4 illustrates in partial view an embodiment of the multi-link conveyor chain of the invention designated generally by reference numeral 11. For the sake of clarity, the elongate pins are omitted.

The multi-link conveyor chain 11 provides a flat surface 12 upon which may be carried articles such as glass bottles to a processing station. The multi-link conveyor chain 11 comprises a series of elongate pins of elliptical section upon which are mounted a number of link plates 14. Each pair of consecutive link plates (16 and 17 for example) is spaced apart along an elongate pin. Link plates (16, 17 and 18 for example) are mounted consecutively in a staggered fashion along a first, second and third elongate pin.

Each of the plurality of link plates 14 has twin links 14a, 14b having a substantially teardrop profile which extends into a flat-edged, sprocket engaging tooth 14c. Each link 14a, 14b is connected by a connecting portion 32. A non-circular aperture 30 in link 14a non-identically matches the elliptical section of an elongate pin. The aperture 30 is substantially elliptical with an enlarged side portion 30a extending inwardly towards connecting portion 32.

To assemble the multi-link conveyor chain 11 of FIG. 2a, the first end of each of a pair of elongate pins of elliptical section is fitted with a first flat pin head by spin riveting. The second end of each of the pair of elongate pins is inserted into the first and second elliptical apertures 5 and 6 (respectively at positions A and B) of a first enclosure member 41 and through the plurality of link plates to a position in which the first flat pin heads are seated in the counterbores 5a and 6a respectively. The second end of each of the pair of elongate pins extends beyond the outermost link plate and is inserted into the first and second elliptical apertures 5 and 6 respectively of a second enclosure member 40. Each enclosure member 40 and 41 is as hereinbefore described with reference to FIGS. 1 to 3. The second end of each of the pair of elongate pins is secured with a flat pin head seated in the counterbore 5a and 6a. This may be produced by eccentrically spill riveting a piece of carbide as hereinbefore described to the second end of the elongate pin within the counterbore. In this manner, the ends of each elongate pin may be protected using first and second enclosure members.

1. A multi-link conveyor chain adapted to provide a substantially flat horizontal surface driveable between a first and a second processing station by engagement with a drive sprocket, said multi-link conveyor chain comprising:
a plurality of elongate pins spaced apart in substantially parallel relationship including a first elongate pin adjacent to a second elongate pin,
wherein the first elongate pin has a first end extending beyond a first edge of the substantially flat horizontal surface and a second end extending beyond a second edge of the substantially flat horizontal surface and
wherein the second elongate pin has a first end extending beyond the first edge of the substantially flat horizontal surface and a second end extending beyond the second edge of the substantially flat horizontal surface;
a plurality of link plates mounted on adjacent elongate pins having a first link connected to a second link by a connecting portion, each of the first and the second link having a main body and a circumferentially dependent sprocket engaging member, said main body defining an aperture whose shape essentially matches the section of an elongate pin;
a first enclosure member positioned at the first edge of the substantially flat horizontal surface comprising:
a main body defining a first aperture and a second aperture, wherein the shape of the first and second aperture essentially matches the section of the first elongate pin and second elongate pin respectively and the depth of the first and second aperture is sufficient to enclose the first end of the first elongate pin and the first end of the second elongate pin respectively;
a second enclosure member positioned at the second edge of the substantially flat horizontal surface comprising:
a main body defining a third aperture and a fourth aperture, wherein the shape of the third and fourth aperture essentially matches the section of the first elongate pin and second elongate pin respectively and the depth of the third and fourth aperture is sufficient to enclose the second end of the first elongate pin and the second end of the second elongate pin respectively; and
a first pin head secured to and retaining the first end of the first elongate pin and seated in a non-tapered counterbore of the first aperture,
a second pin head secured to and retaining the first end of the second elongate pin and seated in a non-tapered counterbore of the second aperture,
a third pin head secured to and retaining the second end of the first elongate pin and seated in a non-tapered counterbore of the third aperture, and
a fourth pin head secured to and retaining the second end of the second elongate pin and seated in a non-tapered counterbore of the fourth aperture,
wherein the ratio of the depth of the non-tapered counterbore to the thickness of the enclosure member is in the range 0.58 to 0.80.

2. A multi-link conveyor chain as claimed in claim 1 comprising: a plurality of the first and second enclosure members positioned respectively at the first and second edges of the substantially flat horizontal surface so as to enclose the first and second end of each of the plurality of elongate members.

3. A multi-link conveyor chain as claimed in claim 1 wherein the main body of each of the first and second enclosure member has a substantially trapezoidal section.

4. A multi-link conveyor chain as claimed in claim 3 wherein the main body has a first side substantially parallel to a second side, wherein the second side is longer than the first side and has rounded corners.

5. A multi-link conveyor chain as claimed in claim 4 wherein the rear face of the main body is recessed.

6. A multi-link conveyor chain as claimed in claim 4 wherein the first side is open.

7. A multi-link conveyor chain as claimed in claim 6 wherein the enclosure member is adapted for use in centre guide conveyor chains.

8. A multi-link conveyor chain as claimed in claim 4 wherein the first side is closed and the rear face is recessed and the enclosure member is adapted for use in side guide conveyor chains.

9. A multi-link conveyor chain as claimed in claim 4 wherein the first side is closed and the rear face is non-recessed and the enclosure member is adapted for use in multi-guide conveyor chains.

10. A multi-link conveyor chain as claimed in claim 1 wherein the main body of each of the first and the second link of a link plate defines a non-circular aperture whose shape non-identically matches the non-circular section of the elongate pin.

11. A multi-link conveyor chain as claimed in claim 1 comprising: a plurality of elongate pins spaced apart in substantially parallel relationship including the first elongate pin adjacent to the second elongate pin which is adjacent to a third elongate pin, each of said elongate pins having a first end, a second end and a non-circular section, wherein a plurality of link plates are consecutively mounted in a staggered fashion along the first, second and third elongate pin.

12. (canceled)

13. An enclosure member adapted to provide a substantially flat horizontal surface driveable between a first and a second processing station by engagement with a drive sprocket, the multi-link conveyor chain comprising a plurality of elongate pins and a plurality of link plates, the elongate pins being spaced apart in substantially parallel relationship including a first elongate pin adjacent to a second elongate pin, each of the elongate pins having a first end, a second end and a non-circular section, the first end of each elongate pin extending beyond a first edge of the substantially flat horizontal surface and a second end of each elongate pin extending beyond a second edge of the substantially flat horizontal surface, the link plates being mounted on adjacent elongate pins having a first link connected to a second link by a connecting portion, each of the first and the second link having a main body and a circumferentially dependent sprocket engaging member, the main body of each of the first and second link defining a non-circular aperture whose shape essentially matches the non-circular section of an elongate pin, the enclosure member being positioned at the first edge of the substantially flat horizontal surface and comprising:
a main body defining a first non-circular aperture and a second non-circular aperture, wherein the shape of the first and second non-circular aperture essentially matches the non-circular section of the first elongate pin and second elongate pin respectively and the depth of the first and second non-circular aperture is sufficient to enclose the first end of the first elongate pin and the first end of the second elongate pin respectively,
a non-tapered counterbore in each of the first and second non-circular apertures for seating a first flat pin head secured to and retaining the first end of the first elongate pin and for seating a second flat pin head secured to and retaining the first end of the second elongate pin, wherein the ratio of the depth of the non-tapered counterbore to the thickness of the enclosure member is in the range 0.58 to 0.80.
